(19) United States
(12) Patent Application Publication
(10) Pub. No.: US 2025/0024814 A1
(43) Pub. Date: Jan. 23, 2025

(54) Canine Nursing Bed Device

(71) Applicant: Teresa Anderson, Albany, GA (US)

(72) Inventor: Teresa Anderson, Albany, GA (US)

(21) Appl. No.: 18/754,538

(22) Filed: Jun. 26, 2024

Related U.S. Application Data
(60) Provisional application No. 63/514,608, filed on Jul. 20, 2023.

(51) Int. Cl. A01K 1/035

(52) U.S. Cl. CPC A01K 1/0353

(57) ABSTRACT

A pet bed nursing device is disclosed that allows a nursing mother dog to lay on their back while nursing puppies. The pet bed nursing device comprises a body component that is configured in a rectangular shape with a central recessed area for the mother dog to lay on her back. The central recessed area also has an elevated head section, such that when the mother dog is on her back, her head is elevated for comfort. Further, the central recessed area creates an elevated side area on either side of the recessed area, allowing the plurality of puppies to lay and nurse. Thus, the central recessed area and the elevated side areas prevent a mother dog from rolling onto her puppies during nursing and ensure the puppies remain at the same level as the mother dog's nipples.

### CROSS-REFERENCE TO RELATED APPLICATION

The present application claims priority to, and the benefit of, U.S. Provisional Application No. 63/514,608, which was filed on Jul. 20, 2023, and is incorporated herein by reference in its entirety.

### FIELD OF THE INVENTION

The present invention relates generally to the field of pet bed nursing devices. More specifically, the present invention relates to a pet bed designed for mothers and feeding animals, such as puppies, to safely nurse. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in pet bed nursing devices. Generally, dogs who have recently given birth may be exhausted and unable to properly position themselves to accommodate a full litter of feeding puppies. Further, dogs who have had a C-section do not come out of surgery with motherly instincts and may resist nursing. Additionally, some puppies may have trouble accessing the nipples, ultimately fighting other puppies because their mother is lying on the side. Thus, mother dogs may accidentally roll on the puppies and hurt them while nursing.

Additionally, if puppies cannot access their mother's nipples, they may not get enough food and exhibit failure to thrive. Puppies need a means for easily and efficiently accessing their mother's nipples, allowing them to feed when necessary. Further, the nursing means should allow all puppies to easily access their mother's nipples, without having to fight other puppies for food.

Accordingly, there is a demand for a pet bed nursing device that allows puppies to easily surround their mother on elevated areas of the bed, rather than struggling to locate a nipple to feed. More particularly, there is a demand for a pet bed nursing device that prevents the mother dog from rolling onto her puppies while they are nursing.

Therefore, there exists a long-felt need in the art for a pet bed nursing device that provides users with a dog bed designed for mothers and feeding puppies. There is also a long-felt need in the art for a pet bed nursing device that features a recessed area in the center of the bed for a mother dog to lay on their back with the head elevated, maximizing comfort as puppies are nursing. Further, there is a long-felt need in the art for a pet bed nursing device that allows puppies to surround the mother on the elevated areas on the bed rather than struggling to locate a nipple to feed. Moreover, there is a long-felt need in the art for a device that prevents the mother dog from rolling onto puppies while they are nursing. Further, there is a long-felt need in the art for a pet bed nursing device that includes a small compartment or pocket to accommodate accessories, supplies, and products associated with nursing puppies. Finally, there is a long-felt need in the art for a pet bed nursing device that includes a washable cover.

The subject matter disclosed and claimed herein, in one embodiment thereof, comprises a pet bed nursing device. The device is a dog bed that allows a nursing mother dog to lay on their back while nursing puppies. The pet bed nursing device comprises a body component that is configured in a rectangular shape with a central recessed area for the mother dog to lay on her back. The central recessed area also has an elevated head section, such that when the mother dog is on her back, her head is elevated for comfort. Further, the central recessed area creates an elevated side area on either side of the recessed area, allowing the plurality of puppies to lay and nurse. Thus, the central recessed area and the elevated side areas prevent a mother dog from rolling onto her puppies during nursing and ensure the puppies remain at the same level as the mother dog's nipples. Further, the bed device comprises a washable cover, a strap system to secure the mother dog in place, and a pocket component to receive various dog-related tools, supplies, or products.

In this manner, the pet bed nursing device of the present invention accomplishes all of the foregoing objectives and provides users with a device that aids nursing mother dogs and feeding puppies. The device is a dog bed with a central recessed area for the mother dog. The device can be manufactured of a foam material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet bed nursing device. The device is a dog bed that allows a nursing mother dog to lay on their back while nursing puppies. The pet bed nursing device comprises a body component that is configured in a rectangular shape with a central recessed area for the mother dog to lay on her back. The central recessed area also has an elevated head section, such that when the mother dog is on her back, her head is elevated for comfort. Further, the central recessed area creates an elevated side area on either side of the recessed area, allowing the plurality of puppies to lay and nurse. Thus, the central recessed area and the elevated side areas prevent a mother dog from rolling onto her puppies during nursing and ensure the puppies remain at the same level as the mother dog's nipples.

In one embodiment, the pet bed nursing device of the present invention is a pet bed for animals that are nursing. Accordingly, the pet bed nursing device may be for any pet but is particularly suitable for a dog. The pet bed nursing device can be utilized by dogs, cats, or any other suitable nursing animal as is known in the art. Further, the design and configuration of the pet bed allows a mother dog or other animal to lay comfortably on the body component on their backs to nurse.

In one embodiment, the pet bed nursing device comprises a body component that is a cushioned rectangular base but could be configured in any suitable shape as is known in the art. Specifically, the body component comprises a top surface, a bottom surface, opposing side walls, and opposing top and bottom walls. The body component comprises a central recessed area, opposing elevated side areas, and an elevated head section. In one embodiment, the body component is a generally flat, rectangular center base portion. In the generally flat, rectangular center base portion, there is formed the central recessed area and the opposing elevated side areas. The central recessed area is a specially formed comfort zone which is designed to support a mother dog on her back and to provide a supportive head area for comfort while nursing. These areas are sculpted to achieve maximum comfort for the mother dog and puppies while nursing.

In one embodiment, the body component is a cushioned base defined by a central recessed area within the top surface and opposing elevated side areas on either side of the central recessed area. The central recessed area and elevated side areas can be any suitable size and shape as is known in the art. Further, the opposing elevated side areas are generally parallel to each other and parallel to the central recessed area. The central recessed area allows for the elevated side areas, on opposing sides of the recessed area. The elevated side areas and the central recessed area are generally the same size and shape but can be different sizes and shapes as well. The side areas are elevated in relation to the central area, allowing a mother dog to be positioned on her back within the central recessed area and her puppies to be supported on the elevated side areas. Once elevated, the puppies would be at the same level as the mother dog's nipples, to allow for easy nursing.

In one embodiment, the central recessed area also comprises an elevated head section. The elevated head section can be any suitable shape and size, as long as it acts to allow a mother dog to rest her head while lying on the body component. Specifically, the elevated head section acts as a cushion to aid in comforting the mother dog's head when using the pet bed device while nursing.

In one embodiment, the body component is configured in a rectangular-shape, similar to a conventional pet bed. In this embodiment, the body component may include a width of between 20-30 inches and a length of between 30-45 inches. However, the pet bed nursing device can be available in multiple sizes, depending on the size of the pet, and it should be appreciated that the specifications may vary and the measurements given are not meant to be limiting. In addition, in other embodiments, the body component may include shapes other than the rectangular shape. For example, the body component may be square-shape, circular-shape, triangle-shape, etc.

In one embodiment, the body component further comprises a cover that is configured to cover the body component and act as a protector to the body component and also provide added softness and comfort to the pet. The cover may preferably be constructed from a fabric able to be washed so that the cover may be removed from the body component and washed to remove debris, pet hair, etc., rather than having to wash the body component itself. In one embodiment, the cover is manufactured of a plush material to provide softness, warmth, and comfort to the pet. Thus, the fabric may be cotton, fleece, wool, polyester, etc., or combinations thereof. However, other materials are contemplated, as well. The cover also comprises a fastening closure, such as a zipper, velcro, snaps, etc.

In one embodiment, the body component comprises a strap system for securing the mother dog in place. The strap system is a set of straps that are secured to the body component, typically within the central recessed area via sewing, adhesives, velcro, etc. In another embodiment, the set of straps are secured to the bottom surface of the body component and wrap around the outside of the body component and over the elevated side areas to secure the mother dog to the device. The set of straps are sized such that they can easily wrap around a pet and be secured. The set of straps are typically fastened around a pet's middle and are secured via velcro, buttons, snaps, buckles, etc., or any other releasably securing means as is known in the art.

In one embodiment, the body component comprises a compartment or pocket component. The pocket component can be any size and shape as is known in the art and can be positioned on any suitable area of the body component. The pocket component is typically sized and shaped to hold a plurality of dog-related tools, supplies, products, etc. Further, the pocket component comprises a means for closing the pocket component and sealing the contents within, such as a zipper, velcro, snaps, buttons, etc. Additionally, the body component can comprise a plurality of pocket components, thus any suitable number of pocket components can be included with the body component as is known in the art, depending on the needs and/or wants of a user.

In one embodiment, the body component may be constructed from a molded foam material. The foam material may be firm but soft to allow for proper support of the pet whilst providing comfort. In one embodiment, the foam material may include polyurethane. In one embodiment, the foam material may be memory foam to provide an elasticity to the body component. In another embodiment, the body component is molded of a polyurethane closed cell foam, visco-clastic foam, or some combination of the two. Further, the pet bed nursing device can also be given a coating of vinyl or other “spray-on” soft plastic coating to cover any or all of its surfaces to improve moisture resistance, without significant loss of its comforting properties.

In one embodiment, the pet bed nursing device may be able to be personalized with indicia, such as the dog's name, initials, monogram, nickname, special date, etc.

In yet another embodiment, a method of allowing a mother dog to easily nurse her puppies in comfort is disclosed. The method includes the steps of providing a pet bed nursing device comprising a central recessed area, opposing elevated side areas, and an elevated head area. The method also comprises positioning the mother dog on her back within the central recessed area. Further, the method comprises positioning the mother dog's head on the elevated head area. Finally, the method comprises positioning the puppies on the opposing elevated side areas, such that they are at the same level as the mother dog's nipples and can easily nurse without issues.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top-perspective view of one embodiment of the pet bed nursing device of the present invention showing the device in use in accordance with the disclosed architecture;

FIG. 2 illustrates a top-perspective view of one embodiment of the pet bed nursing device of the present invention showing the washable cover in accordance with the disclosed architecture;

FIG. 3 illustrates a perspective view of one embodiment of the pet bed nursing device of the present invention showing the central recessed area for the mother dog in accordance with the disclosed architecture;

FIG. 4 illustrates a perspective view of one embodiment of the pet bed nursing device of the present invention showing the elevated side areas for the nursing puppies in accordance with the disclosed architecture;

FIG. 5 illustrates a perspective view of one embodiment of the pet bed nursing device of the present invention showing the pocket component and strap system for the device in accordance with the disclosed architecture; and

FIG. 6 illustrates a flowchart showing the method of allowing a mother dog to easily nurse her puppies in comfort in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pet bed nursing device that provides users with a dog bed designed for mothers and feeding puppies. There is also a long-felt need in the art for a pet bed nursing device that features a recessed area in the center of the bed for a mother dog to lay on their back with the head elevated, maximizing comfort as puppies are nursing. Further, there is a long-felt need in the art for a pet bed nursing device that allows puppies to surround the mother on the elevated areas on the bed rather than struggling to locate a nipple to feed. Moreover, there is a long-felt need in the art for a device that prevents the mother dog from rolling onto puppies while they are nursing. Further, there is a long-felt need in the art for a pet bed nursing device that includes a small compartment or pocket to accommodate accessories, supplies, and products associated with nursing puppies. Finally, there is a long-felt need in the art for a pet bed nursing device that includes a washable cover.

The present invention, in one exemplary embodiment, is a novel pet bed nursing device. The device is a dog bed that allows a nursing mother dog to lay on their back while nursing puppies. The pet bed nursing device comprises a body component that is configured in a rectangular shape with a central recessed area for the mother dog to lay on her back. The central recessed area also has an elevated head section, such that when the mother dog is on her back, her head is elevated for comfort. Further, the central recessed area creates an elevated side area on either side of the recessed area, allowing the plurality of puppies to lay and nurse. Thus, the central recessed area and the elevated side areas prevent a mother dog from rolling onto her puppies during nursing and ensure the puppies remain at the same level as the mother dog's nipples. The present invention also includes a novel method of allowing a mother dog to easily nurse her puppies in comfort. The method includes the steps of providing a pet bed nursing device comprising a central recessed area, opposing elevated side areas, and an elevated head area. The method also comprises positioning the mother dog on her back within the central recessed area. Further, the method comprises positioning the mother dog's head on the elevated head area. Finally, the method comprises positioning the puppies on the opposing elevated side areas, such that they are at the same level as the mother dog's nipples and can easily nurse without issues.

Referring initially to the drawings, FIG. 1 illustrates a perspective view of one embodiment of the pet bed nursing device 100 of the present invention. In the present embodiment, the pet bed nursing device 100 is an improved pet bed nursing device 100 that provides a user with a dog bed that allows a nursing mother dog 110 to lay on their back while nursing puppies 112. Specifically, the pet bed nursing device 100 comprises a body component 102 with a central recessed area 104 and opposing elevated side areas 106, and an elevated head area 108. Thus, the central recessed area 104 and the elevated side areas 106 prevent a mother dog 110 from rolling onto her puppies 112 during nursing and ensures the puppies 112 remain at the same level as the mother dog's nipples.

Generally, the pet bed nursing device 100 of the present invention is a pet bed for animals that are nursing. Accordingly, the pet bed nursing device 100 may be for any pet but is particularly suitable for a dog. The pet bed nursing device 100 can be utilized by dogs, cats, or any other suitable nursing animal as is known in the art. Further, the design and configuration of the pet bed device 100 allows a mother dog 110 or other animals to lay comfortably on the body component 102 on their backs to nurse.

Further, the pet bed nursing device 100 comprises a body component 102 that is a cushioned rectangular base but could be configured in any suitable shape as is known in the art. Specifically, the body component 102 comprises a top surface 114, a bottom surface 116, opposing side walls 118, and opposing top and bottom walls 120. The body component 102 comprises a central recessed area 104, opposing elevated side areas 106, and an elevated head section 108. In one embodiment, the body component 102 is a generally flat, rectangular center base portion. In the generally flat, rectangular center base portion, there is formed the central recessed area 104 and the opposing elevated side areas 106. The central recessed area 104 is a specially formed comfort zone which is designed to support a mother dog 110 on her back and to provide a supportive head area 108 for comfort while nursing. These areas are sculpted to achieve maximum comfort for the mother dog 110 and puppies 112 while nursing.

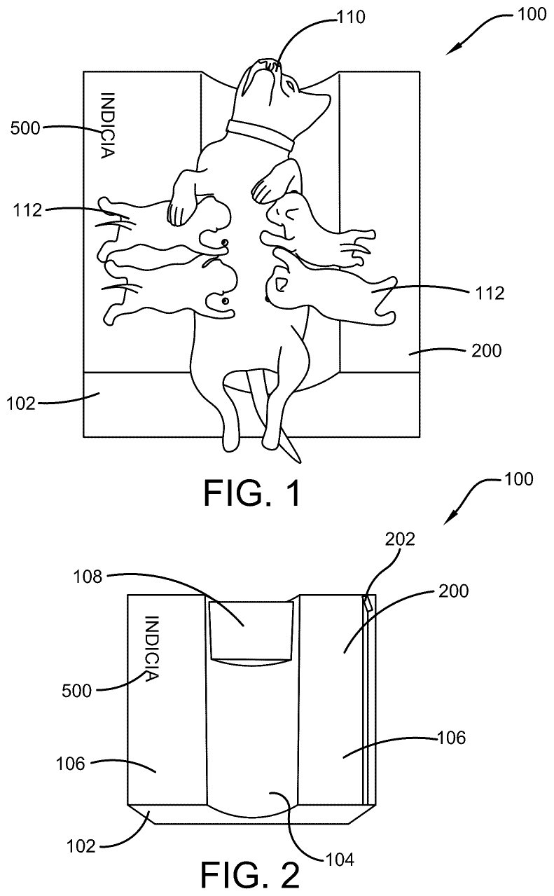

As shown in FIG. 2, the body component 102 further comprises a cover 200 that is configured to cover the body component 102 and act as a protector to the body component 102 and also provide added softness and comfort to the pet. The cover 200 may preferably be constructed from a fabric able to be washed so that the cover 200 may be removed from the body component 102 and washed to remove debris, pet hair, etc., rather than having to wash the body component 102 itself. In one embodiment, the cover 200 is manufactured of a plush material to provide softness, warmth, and comfort to the pet. Thus, the fabric may be cotton, fleece, wool, polyester, etc., or combinations thereof. However, other materials are contemplated, as well. The cover 200 also comprises a fastening closure 202, such as a zipper, velcro, snaps, buttons, etc., or any other suitable securing means as is known in the art.

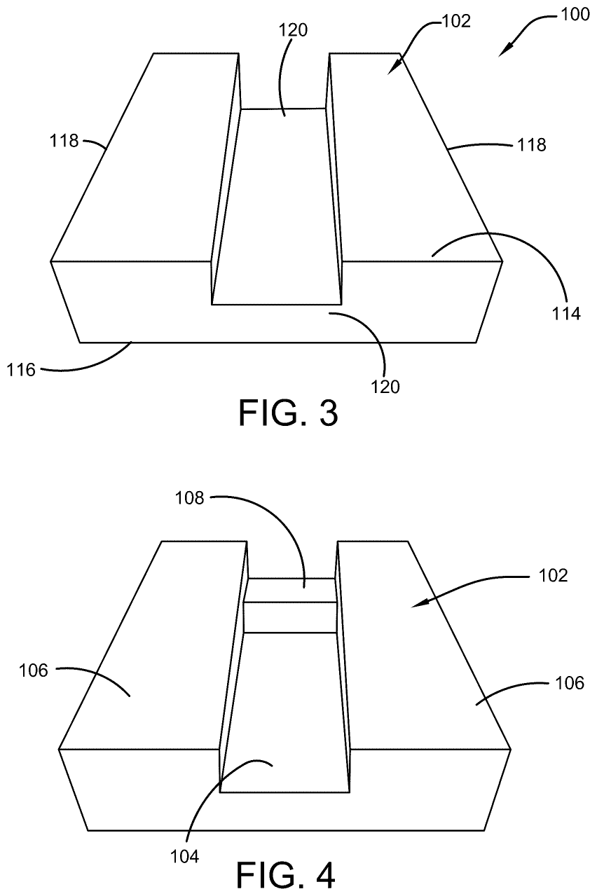

As shown in FIGS. 3-4, the body component 102 is a cushioned base defined by a central recessed area 104 within the top surface 114 and opposing elevated side areas 106 on either side of the central recessed area 104. The central recessed area 104 and elevated side areas 106 can be any suitable size and shape as is known in the art. Further, the opposing elevated side areas 106 are generally parallel to each other and parallel to the central recessed area 104. The central recessed area 104 allows for the elevated side areas 106, on opposing sides of the recessed area 104. The elevated side areas 106 and the central recessed area 104 are generally the same size and shape but can be different sizes and shapes as well. The side areas 106 are elevated in relation to the central area 104, allowing a mother dog 110 to be positioned on her back within the central recessed area 104 and her puppies 112 to be supported on the elevated side areas 106. Once elevated, the puppies 112 would be at the same level as the mother dog's nipples, to allow for easy nursing.

Furthermore, the central recessed area 104 also comprises an elevated head section 108. The elevated head section 108 can be any suitable shape and size, as long as it acts to allow a mother dog 110 to rest her head while lying on the body component 102. Specifically, the elevated head section 108 acts as a cushion to aid in comforting the mother dog's head when using the pet bed device 100 while nursing.

Additionally, the body component 102 is configured in a rectangular-shape, similar to a conventional pet bed. In this embodiment, the body component 102 may include a width of between 20-30 inches and a length of between 30-45 inches. However, the pet bed nursing device 100 can be available in multiple sizes, depending on the size of the pet, and it should be appreciated that the specifications may vary and the measurements given are not meant to be limiting. In addition, in other embodiments, the body component 102 may include shapes other than the rectangular shape. For example, the body component 102 may be square-shape, circular-shape, triangle-shape, etc., or any other suitable shape as is known in the art.

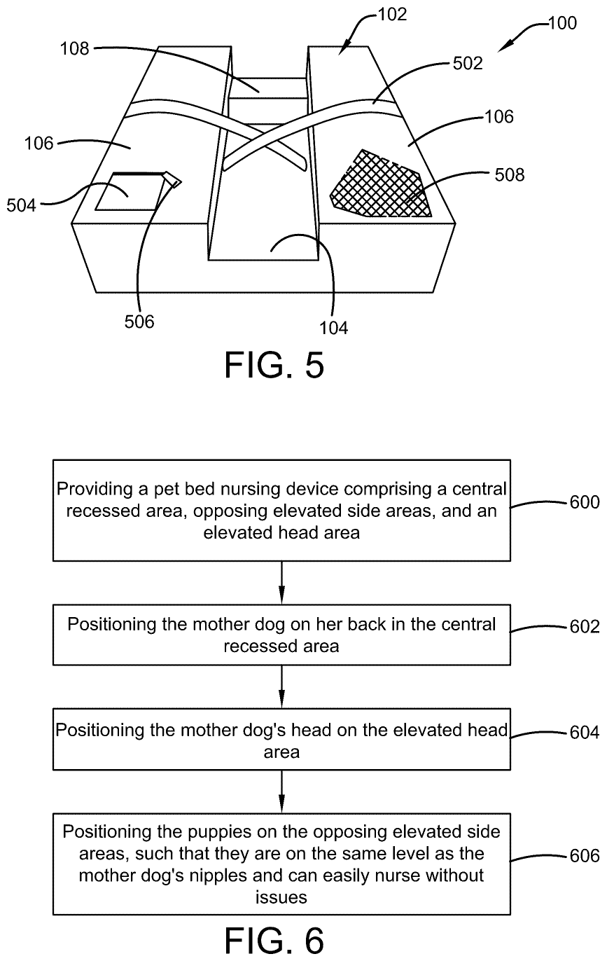

As shown in FIG. 5, in one embodiment, the body component 102 comprises a strap system 502 for securing the mother dog 110 in place. The strap system 502 is a set of straps that are secured to the body component 102, typically within the central recessed area 104 via sewing, adhesives, velcro, etc. In another embodiment, the set of straps 502 are secured to the bottom surface 116 of the body component 102 and wrap around the outside of the body component 102 and over the elevated side areas 106 to secure the mother dog 110 to the device 100. The set of straps 502 are sized such that they can easily wrap around a pet and be secured. The set of straps 502 are typically fastened around a pet's middle and are secured via velcro, buttons, snaps, buckles, etc., or any other releasably securing means as is known in the art.

In another embodiment, the body component 102 comprises a compartment or pocket component 504. The pocket component 504 can be any size and shape as is known in the art and can be positioned on any suitable area of the body component 102. The pocket component 504 is typically sized and shaped to hold a plurality of dog-related tools, supplies, products, etc. Further, the pocket component 504 comprises a means 506 for closing the pocket component 504 and sealing the contents within, such as a zipper, velcro, snaps, buttons, etc. Additionally, the body component 102 can comprise a plurality of pocket components 504, thus any suitable number of pocket components 504 can be included with the body component 102 as is known in the art, depending on the needs and/or wants of a user.

Furthermore, the body component 102 may be constructed from a molded foam material. The foam material may be firm but soft to allow for proper support of the pet whilst providing comfort. In one embodiment, the foam material may include polyurethane. In one embodiment, the foam material may be memory foam to provide an elasticity to the body component 102. In another embodiment, the body component 102 is molded of a polyurethane closed cell foam, visco-elastic foam, or some combination of the two. Further, the pet bed nursing device 100 can also be given a coating 508 of vinyl or other “spray-on” soft plastic coating to cover any or all of its surfaces to improve moisture resistance, without significant loss of its comforting properties.

In yet another embodiment, the pet bed nursing device 100 may be able to be personalized with indicia 500, such as the dog's name, initials, monogram, nickname, special date, etc. Further, the body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be dog, nursing, or brand related.

FIG. 6 illustrates a flowchart of the method of allowing a mother dog to easily nurse her puppies in comfort. The method includes the steps of at 600, providing a pet bed nursing device comprising a central recessed area, opposing elevated side areas, and an elevated head area. The method also comprises at 602, positioning the mother dog on her back within the central recessed area. Further, the method comprises at 604, positioning the mother dog's head on the elevated head area. Finally, the method comprises at 606, positioning the puppies on the opposing elevated side areas, such that they are at the same level as the mother dog's nipples and can easily nurse without issues.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet bed nursing device”, “pet bed device”, “nursing device”, and “device” are interchangeable and refer to the pet bed nursing device 100 of the present invention.

Notwithstanding the foregoing, the pet bed nursing device 100 of the present invention can be of any suitable size and configuration as is known in the art without affecting the overall concept of the invention, provided that it accomplishes the above-stated objectives. One of ordinary skill in the art will appreciate that the pet bed nursing device 100 as shown in FIGS. 1-6 is for illustrative purposes only, and that many other sizes and shapes of the pet bed nursing device 100 are well within the scope of the present disclosure. Although the dimensions of the pet bed nursing device 100 are important design parameters for user convenience, the pet bed nursing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet bed nursing device that provides a user with a dog bed that promotes a nursing mother dog to lay on her back while nursing puppies, the pet bed nursing device comprising:
a body component; and
wherein the body component comprises a central recessed area and opposing elevated side areas;
wherein the nursing mother dog is placed on her back in the central recessed area;
wherein a plurality of puppies are positioned on the opposing elevated side areas, such that the plurality of puppies are at a same level as the nursing mother dog's nipples; and
further wherein the central recessed area prevents the nursing mother dog from rolling onto the plurality of puppies.

2. The pet bed nursing device of claim 1, wherein the pet bed nursing device can be utilized with any nursing pet.

3. The pet bed nursing device of claim 2, wherein the body component is a cushioned rectangular base that comprises a top surface, a bottom surface, opposing side walls, and opposing top and bottom walls.

4. The pet bed nursing device of claim 3, wherein the body component comprises a cover that is configured to cover the body component and act as a protector to the body component.

5. The pet bed nursing device of claim 4, wherein the cover comprises a fastening closure for releasably securing the cover to the body component.

6. The pet bed nursing device of claim 5, wherein the central recessed area is positioned within the top surface of the body component and the opposing elevated side areas are positioned on either side of the central recessed area.

7. The pet bed nursing device of claim 6, wherein the opposing elevated side areas and the central recessed area are generally parallel to each other.

8. The pet bed nursing device of claim 7, wherein the central recessed area comprises an elevated head section for the nursing mother dog.

9. The pet bed nursing device of claim 8, wherein the body component comprises a set of straps for securing the nursing mother dog in place.

10. The pet bed nursing device of claim 9, wherein the set of straps are secured to the central recessed area and wrap around a middle of the nursing mother dog and are fastened.

11. The pet bed nursing device of claim 10, wherein the body component comprises a pocket component with a closing means.

12. The pet bed nursing device of claim 11, wherein the pocket component is sized to hold a plurality of dog-related tools, supplies, and products.

13. A pet bed nursing device that provides a user with a dog bed that promotes a nursing mother dog to lay on her back while nursing puppies, the pet bed nursing device comprising:
a body component that is a cushioned rectangular base that comprises a top surface, a bottom surface, opposing side walls, and opposing top and bottom walls; and
wherein the body component comprises a central recessed area and opposing elevated side areas;
wherein the central recessed area is positioned within the top surface of the body component and the opposing elevated side areas are positioned on either side of the central recessed area;
wherein the central recessed area comprises an elevated head section for the nursing mother dog;
wherein the body component comprises a cover and a fastening closure for securing the cover to the body component;
wherein the body component comprises a pocket component with a closing means for retaining a plurality of dog-related tools, supplies, and products;
wherein the mother nursing dog is placed on her back in the central recessed area;
wherein a plurality of puppies are positioned on the opposing elevated side areas, such that the plurality of puppies are at a same level as the nursing mother dog's nipples; and
wherein the central recessed area prevents the nursing mother dog from rolling onto the plurality of puppies.

14. The pet bed nursing device of claim 13, wherein the body component comprises a set of straps for securing the nursing mother dog in place.

15. The pet bed nursing device of claim 14, wherein the set of straps are secured to the bottom surface of the body component and wrap around outside of the body component and over the elevated side areas to secure the nursing mother dog to the pet bed nursing device.

16. The pet bed nursing device of claim 13, wherein the body component comprises a coating for moisture resistance.

17. The pet bed nursing device of claim 13 further comprising a plurality of indicia.

18. The pet bed nursing device of claim 17 wherein the plurality of indicia includes a dog's name, initials, monogram, nickname, or special date.

19. The pet bed nursing device of claim 13 wherein the body component is manufactured of a polyurethane closed cell foam or visco-elastic foam or combination of the two.

20. A method of allowing a mother dog to easily nurse her puppies in comfort, the method comprising the following steps:
providing a pet bed nursing device comprising a central recessed area, opposing elevated side areas, and an elevated head area;
positioning the mother dog on her back within the central recessed area;
positioning the mother dog's head on the elevated head area; and
positioning the puppies on the opposing elevated side areas, such that they are the same level as the mother dog's nipples and can easily nurse without issues.
